(19) United States
(12) Patent Application Publication
(10) Pub. No.: US 2025/0203638 A1
(43) Pub. Date: Jun. 19, 2025

(54) METHODS FOR SELECTING RESOURCES FOR SIDELINKS AND RELATED DEVICES

(71) Applicant: Sony Group Corporation, Tokyo (JP)

(72) Inventor: Xiaoxue WANG, Beijing (CN)

(73) Assignee: Sony Group Corporation, Tokyo (JP)

(21) Appl. No.: 18/847,730

(22) PCT Filed: Mar. 28, 2023
(86) PCT No.: PCT/CN2023/084278

§ 371 Date: Sep. 17, 2024

(30) Foreign Application Priority Data
Mar. 31, 2022 (CN) 202210337858.1

(51) Int. Cl. H04W 72/40; H04W 72/0453; H04W 74/0808

(52) U.S. Cl. CPC H04W 72/40; H04W 72/0453; H04W 74/0808

(57) ABSTRACT

The present disclosure relates to methods for selecting resources for sidelinks and related devices. Disclosed is an electronic device for a user equipment (UE). The electronic device is configured to determine, based on resource configuration information, a licensed frequency band resource pool and an unlicensed frequency band resource pool that are available to a sidelink transmission of the UE, and determine, from the licensed frequency band resource pool and the unlicensed frequency band resource pool, a candidate resource set for the sidelink transmission of the UE.

### CROSS-REFERENCE TO RELATED APPLICATIONS

This application claims the priority of Chinese patent application with application number 202210337858.1, titled “METHODS FOR SELECTING RESOURCES FOR SIDELINKS AND RELATED DEVICES” filed on Mar. 31, 2022, the entire content of which is incorporated herein by reference.

### TECHNICAL FIELD

The present disclosure relates to a field of wireless communication, and in particular, to methods for selecting resources for sidelinks and related devices.

### BACKGROUND

In a wireless communication system, a sidelink may enable a plurality of user equipments (UEs) to communicate in a peer-to-peer (i.e., direct) manner without having to go through a certain wireless access point (AP) or a base station (BS). Therefore, the sidelink may be used to carry communications in the Internet of Things, such as Device-to-Device (D2D) communications. One example of D2D communication is Vehicle to Everything (V2X) communication associated with a vehicle.

Conventionally, a sidelink transmission only occurs in a licensed frequency band of the wireless communication system. However, as services that the sidelink may support become increasingly richer, the sidelink require a higher data throughput to support these services. Therefore, the sidelink transmission may require additional resources in addition to resources on the licensed frequency band. Accordingly, a novel method for resource selection to achieve reliable, effective, and flexible resource selection to ensure performance of sidelink transmission is desired.

### SUMMARY

The present disclosure provides methods for resource selection for sidelink transmissions and related devices. In the present disclosure, in addition to a licensed frequency band resource pool, an unlicensed frequency band resource pool is also configured for sidelink transmissions of a UE. When the licensed frequency band resource pool and the unlicensed frequency band resource pool coexist, the method for resource selection according to the present disclosure is able to select a suitable candidate resource set from the two resource pools for sidelink transmissions of the UE.

An aspect of the present disclosure relates to an electronic device for a UE, wherein the electronic device comprises processing circuitry configured to: determine, based on resource configuration information, a licensed frequency band resource pool and an unlicensed frequency band resource pool that are available to a sidelink transmission of the UE; and determine, from the licensed frequency band resource pool and the unlicensed frequency band resource pool, a candidate resource set for the sidelink transmission of the UE.

Another aspect of the present disclosure relates to a method performed by a user equipment UE, wherein the method comprises: determining, based on resource configuration information, a licensed frequency band resource pool and an unlicensed frequency band resource pool that are available to a sidelink transmission of the UE; and determining, from the licensed frequency band resource pool and the unlicensed frequency band resource pool, a candidate resource set for the sidelink transmission of the UE.

Another aspect of the present disclosure relates to a computer-readable storage medium having one or more instructions stored thereon, which, when executed by one or more processing circuits of an electronic device, cause the electronic device to perform any of the method as described in the present disclosure.

Another aspect of the disclosure relates to a computer program product comprising a computer program which, when executed by a processor, performs any of the method as described in the present disclosure.

Another aspect of the present disclosure relates to an apparatus comprising means for performing any of the methods as described in the present disclosure.

### BRIEF DESCRIPTION OF THE DRAWINGS

The above and other purposes and advantages of the present disclosure will be further described below in conjunction with specific embodiments and with reference to the accompanying drawings. In the drawings, same or corresponding technical features or components are indicated by same or corresponding reference numerals.

FIG. 1 illustrates an exemplary block diagram of an electronic device according to an embodiment of the present disclosure.

FIG. 2 illustrates an exemplary flowchart of a method for resource selection according to an embodiment of the present disclosure.

FIGS. 3A-3B illustrate example scenarios in which a licensed frequency band resource pool and an unlicensed frequency band resource pool do not overlap in a time domain according to an embodiment of the present disclosure.

FIGS. 3C-3D illustrate example scenarios in which a licensed frequency band resource pool and an unlicensed frequency band resource pool do not overlap in the time domain according to an embodiment of the present disclosure.

FIG. 4 is a block diagram showing a first example of a schematic configuration of a gNB to which the technology of the present disclosure may be applied.

FIG. 5 is a block diagram showing a second example of a schematic configuration of a gNB to which the technology of the present disclosure may be applied.

FIG. 6 is a block diagram showing an example of a schematic configuration of a communication device to which the technology of the present disclosure may be applied.

FIG. 7 is a block diagram showing an example of a schematic configuration of a vehicle navigation device to which the technology of the present disclosure may be applied.

While the embodiments described in the present disclosure may be susceptible to various modifications and alternative forms, specific embodiments thereof are shown by way of example in the drawings and described in detail herein. It should be understood, however, that the drawings and detailed description are not intended to limit the embodiments to the disclosed particular forms, but on the contrary, are intended to cover all modifications, equivalents and alternatives that fall within the spirit and scope of the claims.

### DETAILED DESCRIPTION

Exemplary embodiments of the present disclosure will be described below with reference to the accompanying drawings. For the sake of clarity and conciseness, not all features of the embodiments are described in the specification. It should be understood, however, that many implementation-specific settings must be made in implementing an embodiment in order to achieve the developer's specific goals, for example, to meet those constraints associated with the device and business, and that these constraints may vary from one implementation to another. Moreover, it should also be understood that development work, while potentially very complex and time-consuming, would only be a routine undertaking for those skilled in the art having the benefit of the present disclosure.

It should also be understood that, in order to avoid obscuring the present disclosure with unnecessary details, only the processing steps and/or device structures that are closely related to at least the solution according to the present disclosure are shown in the drawings, while other details that are of little relevance to the present disclosure have been omitted.

### 1. Exemplary Devices

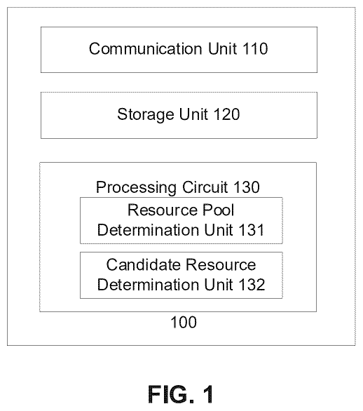

FIG. 1 illustrates an exemplary block diagram of an electronic device 100 according to an embodiment of the present disclosure. The electronic device 100 may include a communication unit 110, a storage unit 120, and a processing circuit 130.

The electronic device 100 may be used to implement a method for resource selection for a sidelink described in the present disclosure. The method for resource selection is executed on UE side of a wireless communication system. Therefore, the electronic device 100 may be implemented on the UE side. The electronic device 100 may be used to perform one or more operations related to a UE as described herein. Specifically, the electronic device 100 may be implemented as the UE itself, as a part of the UE, or as a control device for controlling the UE. For example, the electronic device 100 may be implemented as a chip for controlling the UE. Herein, the electronic device 100 is implemented as the UE itself, which is only for convenience of description and is not intended to impose a limitation.

The communication unit 110 of the electronic device 100 may be used to receive or transmit radio transmissions. The communication unit 110 may be used to establish and maintain one or more communications links. Each communication link may carry associated transmissions. For example, the one or more communication links may be communication links between the electronic device 100 and a base station (not shown).

According to an embodiment of the present disclosure, the one or more communication links may include one or more sidelinks between the electronic device 100 and one or more other UEs (not shown). The communication unit 110 may perform sidelink transmissions with other UEs through the one or more sidelinks using allocated resources. Resources for sidelink transmissions may be determined by the processing circuit 130 based on the method for resource selection described in the present disclosure, which will be further described below.

In an embodiment of the present disclosure, the communication unit 110 may perform functions such as up-conversion, digital-to-analog conversion on radio signals to be transmitted, and/or perform functions such as down-conversion, analog-to-digital conversion on received radio signals. The communication unit 110 may be implemented using various technologies. For example, the communication unit 110 may be implemented as communication interface components, such as an antenna device, a radio frequency circuit, and a portion of a baseband processing circuit.

In FIG. 1, the communication unit 110 is drawn with dashed lines, as it may alternatively be located within the processing circuit 130 or external to the electronic device 100.

The storage unit 120 of the electronic device 100 may store information generated by the processing circuit 130, information received from or sent to other devices through the communication unit 110, programs, machine codes, and data for operations of the electronic device 100, and the like.

According to an embodiment of the present disclosure, the storage unit 120 may store resource configuration information. As further described below, the resource configuration information may be used to determine a licensed frequency band resource pool and an unlicensed frequency band resource pool for sidelink transmissions of the electronic device 100. A “resource pool” used herein may refer to a collection of one or more resources. A “resource” used herein may refer to a time-frequency resource used for wireless transmissions. Each time-frequency resource may have a corresponding time and a corresponding frequency. The time corresponding to a time-frequency resource may refer to one or more time segments (e.g., time slots). Accordingly, performing a radio transmission using a specific time-frequency resource may refer to performing the radio transmission at the specific time segment and frequency corresponding to the specific time-frequency resource.

The storage unit 120 may be a volatile memory and/or a non-volatile memory. For example, the storage unit 120 may include, but is not limited to, a random access memory (RAM), a dynamic random access memory (DRAM), a static random access memory (SRAM), a read only memory (ROM), or a flash memory. The storage unit 120 is drawn with dashed lines, as it may alternatively be located within the processing circuit 130 or external to the electronic device 100.

The processing circuit 130 of the electronic device 100 may be configured to perform one or more operations, thereby providing various functions of the electronic device 100. The processing circuit 130 may perform corresponding operations by executing one or more executable instructions stored in the storage unit 120.

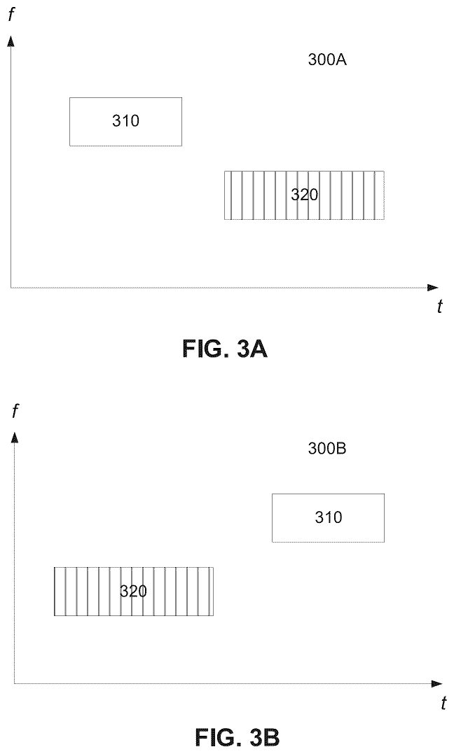

According to an embodiment of the present disclosure, the processing circuit 130 may perform one or more operations, thereby implementing the method for resource selection described herein. To this end, the processing circuit 130 may include a resource pool determination unit 131 and a candidate resource determination unit 132. The resource pool determination unit 131 may be configured to determine, based on resource configuration information, a licensed frequency band resource pool and an unlicensed frequency band resource pool that are available to a sidelink transmission of the electronic device 100 (or, UE). The candidate resource determining unit 132 may be configured to determine, from the licensed frequency band resource pool and the unlicensed frequency band resource pool, a candidate resource set for the sidelink transmission of the electronic device 100. In this way, the electronic device 100 (or UE) may select a candidate resource set for the sidelink transmission from both of the licensed frequency band resource pool and the unlicensed frequency band resource pool. Compared with conventional devices that use only resources on the licensed frequency band, the electronic device 100 according to the embodiment of the present disclosure may form a candidate resource set of a larger size. This helps improve data throughput of the sidelink, allowing the sidelink to have higher data rates, better transmission performance, and support more services. More details of the method for resource selection according to the embodiment of the present disclosure are described below in conjunction with FIG. 3.

It should be understood that the various units described above are exemplary and/or preferred modules for implementing processes described in the present disclosure. These modules may be hardware units (such as central processing units, field programmable gate arrays, digital signal processors or application specific integrated circuits, etc.) and/or software modules (such as computer readable programs). The above content is not exhaustive description of modules used for implementing various steps described below. However, as long as there is a step for performing a certain process, there may be a corresponding module or unit (implemented by hardware and/or software) for implementing that process. Technical solutions defined by all combinations of the steps described below as well as units corresponding to those steps are included in the content of the present disclosure, as long as the technical solutions they constitute are complete and applicable.

Furthermore, a device constituted by various units may be incorporated into a hardware device (such as a computer) as a functional module. In addition to those functional modules, the electronic device may of course have further hardware or software components.

### 2. Exemplary Methods

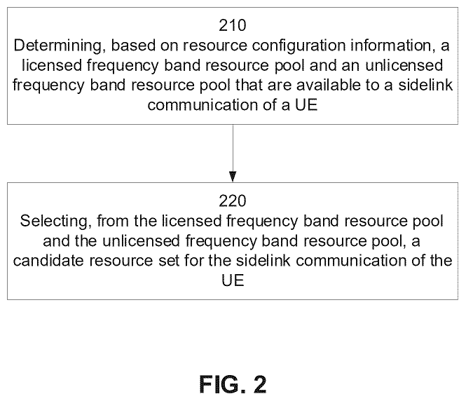

FIG. 2 illustrates an exemplary flowchart of a method for resource selection 200 according to an embodiment of the present disclosure. The method 200 may be performed by a device on the UE side. The device on the UE side may include the UE itself, a part of the UE, or a control device used to control the UE. For example, when the electronic device 100 is used to implement a device on the UE side described in the present disclosure, the method 200 may be performed by the processing circuit 130 of the electronic device 100. Herein, the method 100 is described as being performed by the UE itself, which is only for convenience of description and is not intended to impose a limitation.

According to an embodiment of the present disclosure, the method 200 may be performed in response to an expectation that a sidelink transmission associated with the UE will occur, thereby providing a candidate resource set for the sidelink transmission. For the sidelink transmission, a plurality of resource selection modes may exist. In a first resource selection mode, resources for the sidelink transmission may be selected by a base station, which then directly indicates the selected resources to the UE. The UE may perform the sidelink transmission using the resources selected and indicated by the base station. In a second resource selection mode, resources for the sidelink transmission may be selected by the UE. The second resource selection mode may reduce participation of the base station and improve autonomy of the UE, thereby enabling a customized determination of the resources used for the sidelink transmission and improving flexibility of resource selection. Preferably, the method 200 may be performed in the second resource selection mode.

The method 200 may begin with step 210. In step 210, the UE may be configured to determine, based on resource configuration information, a licensed frequency band resource pool and an unlicensed frequency band resource pool that are available to a sidelink transmission of the UE.

According to an embodiment of the present disclosure, resource configuration information may indicate one or more resources within in a licensed band, each of which is associated with a respective time slot and a respective frequency in the licensed frequency band. The one or more resources form a licensed frequency band resource pool that is available to the sidelink transmission of the UE. A licensed frequency band is a particular frequency interval that is specified by a protocol or a standard of a wireless communication system. The licensed frequency band resource pool may include multiple resources located at a same frequency and different time slots. The licensed frequency band resource pool may also include multiple resources located at a same time slot and different frequencies. As an example, blocks 310 in FIGS. 3A to 3D illustrate a distribution of a licensed frequency band resource pool 310 across a time domain (the horizontal axis) and a frequency domain (the vertical axis).

According to an embodiment of the present disclosure, the resource configuration information may further indicate one or more resources within an unlicensed band, each of which is associated with a respective time slot and a respective frequency in the unlicensed band. The one or more resources form an unlicensed frequency band resource pool that is available to the sidelink transmission of the UE. An unlicensed frequency band is different from the licensed frequency band as specified by the protocol or the standard of the wireless communication system. For example, the unlicensed frequency band may be separated from the licensed frequency band. The unlicensed frequency band resource pool may include multiple resources located at a same frequency and different time slots. The unlicensed frequency band resource pool may also include multiple resources located at a same time slot and different frequencies. As an example, blocks 320 in FIGS. 3A to 3D illustrate a distribution of the unlicensed frequency band resource pool across a time domain (the horizontal axis) and a frequency domain (the vertical axis).

According to an embodiment of the present disclosure, the resource configuration information may have multiple portions, of which a first portion is used to configure the licensed frequency band resource pool, and a second portion that is different from the first portion is used to configure the unlicensed frequency band resource pool. Preferably, the first portion and the second portion of the resource configuration information may be configured independently of each other.

According to an embodiment of the present disclosure, the resource configuration information may be provided to the UE in various ways. For example, the resource configuration information may be preconfigured and/or be dynamically configured by signaling from a base station.

In some embodiments, the resource configuration information may be preconfigured. For example, the resource configuration information may be preloaded in the UE (e.g., in the storage unit 120 of the electronic device 100) by a manufacturer or a seller of the UE. The pre-configuration process may be performed during the production, sale, and/or activation of the UE. As a specific example, a manufacturer of a vehicle may load the resource configuration information into an on-board system of the vehicle. In some cases, different resource configuration information may be preconfigured for different types of UEs.

In some other embodiments, the UE may dynamically receive the resource configuration information from an external device. For example, when the UE is camping on a specific cell, a base station serving the cell may provide the resource configuration information to the UE. The base station may provide resource configuration information to the UE in various ways. For example, the resource configuration information may be included in one or more signalings sent by the base station to the UE. In one example, the base station may send an RRC signaling to the UE. The RRC signaling includes a parameter, SL-ResourcePool, that is associated with the licensed frequency band resource pool, where sl-TimeResource may be used to configure a time domain parameter associated with the licensed frequency band resource pool. Similarly, the base station may send signaling associated with the unlicensed frequency band resource pool to the UE.

In an optional embodiment, the resource configuration information may be provided to the UE in a hybrid configuration. For example, the first portion of the resource configuration information may employ the preconfiguring approach, while the second portion may be dynamically received from an external device. Alternatively, the second portion of the resource configuration information may employ the preconfiguring approach, while the first portion may be dynamically received from the external device.

According to an embodiment of the present disclosure, the UE may parse the stored/received resource configuration information, extract information associated with individual licensed frequency band resources and unlicensed frequency band resources (including time domain configuration information and frequency domain configuration information), thereby determining the licensed frequency band resource pool and the unlicensed frequency band resource pool that are available to the sidelink transmission of the UE.

The method 200 may then proceed to step 220. In step 220, the UE may be configured to determine, from the licensed frequency band resource pool and the unlicensed frequency band resource pool determined in step 210, a candidate resource set for the sidelink transmission of the UE.

The candidate resource set may include one or more candidate resources that are selectable for use by sidelink transmissions. According to an embodiment of the present disclosure, the selection in step 220 may be done based on one or more factors. Depending on the one or more factors, the candidate resource set may be a subset of the licensed frequency band resource pool, may be a subset of the unlicensed frequency band resource pool, or may include both a subset of the licensed frequency band resource pool and a subset of the unlicensed frequency band resource pool.

According to an embodiment of the present disclosure, the one or more factors may include an overlap in a time domain between the licensed frequency band resource pool and the unlicensed frequency band resource pool.

The licensed frequency band resource pool and the unlicensed frequency band resource pool are isolated in the frequency domain but may at least partially overlap in the time domain. If every resource in the licensed frequency band resource pool and every resource in the unlicensed frequency band resource pool correspond to different time slots, the licensed frequency band resource pool and the unlicensed frequency band resource pool do not overlap in the time domain. FIGS. 3A-3B illustrate scenarios 300A and 300B in which a licensed frequency band resource pool 310 and an unlicensed frequency band resource pool 320 do not overlap in the time domain. If a first resource in the licensed frequency band resource pool and a second resource in the unlicensed frequency band resource pool correspond to a same time slot, the licensed frequency band resource pool and the unlicensed frequency band resource pool overlap in the time domain. FIG. 3C illustrates a scenario 300C in which a licensed frequency band resource pool 310 and an unlicensed frequency band resource pool 320 partially overlap in the time domain, and FIG. 3D illustrates a scenario 300D in which a licensed frequency band resource pool 310 and an unlicensed frequency band resource pool 320 fully overlap in the time domain.

According to an embodiment of the present disclosure, the UE may determine, based on the resource configuration information, whether the licensed frequency band resource pool and the unlicensed frequency band resource pool at least partially overlap in the time domain. For example, the UE may compare each time slot associated with the licensed frequency band resource pool to each time slot associated with the unlicensed frequency band resource pool. If the licensed frequency band resource pool and the unlicensed resource pool have one or more common time slots, the licensed frequency band resource pool and the unlicensed resource pool at least partially overlap in the time domain. Preferably, the UE may also determine respective licensed frequency band resources and unlicensed frequency band resources that are overlapping in the time domain.

According to an embodiment of the present disclosure, when the licensed frequency band resource pool and the unlicensed frequency band resource pool do not overlap in the time domain, the UE may be configured to select, from one resource pool of the licensed frequency band resource pool and the unlicensed frequency band resource pool that is earlier in the time domain, one or more candidate resources as at least a portion of the candidate resource set.

In the example scenario of FIG. 3A, the licensed frequency band resource pool 310 is earlier than the unlicensed frequency band resource pool 320 in the time domain. Accordingly, the UE may be configured to select one or more candidate resources from the licensed frequency band resource pool 310 as at least a portion of the candidate resource set. In some embodiments, the UE may select, through a resource sensing operation, the one or more candidate resources from the licensed frequency band resource pool 310.

In the example scenario of FIG. 3B, the unlicensed frequency band resource pool 320 is earlier than the licensed frequency band resource pool 310 in the time domain. Accordingly, the UE may be configured to select one or more candidate resources from the unlicensed frequency band resource pool 320 as at least a portion of the candidate resource set. In some embodiments, the UE may select, through a Listen Before Talk (LBT) operation, the one or more candidate resources from the licensed frequency band resource pool 310.

In 5G NR, other communication systems (for example, Wi-Fi) exist on unlicensed frequency bands. In this case, the UE should try its best to use a fair coexistence mechanism to select resources. Therefore, the selection for resources on an uplink unlicensed frequency band may be performed through the LBT operation. In the LBT operation, the UE may continuously listen to the unlicensed channel. If it is detected that the energy on this channel is below a threshold for a continuous period, the UE may determine that the channel is idle and the UE may occupy the channel for transmission for a certain length of time. Such channel listening has multiple levels. Under different listening levels, the listening periods are different, and the time lengths for which the UE is able to continuously occupy the channel after the LBT operation is successful are also different. In an embodiment of the present disclosure, any suitable listening level may be employed. For example, the highest listening level (Cat4) may be employed. The LBT operation with this listening level requires a longer period to listen to the channel, and the time length for which the UE may occupy the channel after success is also longer. In other embodiments, the LBT operation with any other suitable listening level may also be employed.

According to an embodiment of the present disclosure, the UE may be further configured to select from the one resource pool of the licensed frequency band resource pool and the unlicensed frequency band resource pool that is later in the time domain, one or more additional candidate resources as at least one additional portion of the candidate resource set.

Taking the example scenario of FIG. 3A as an example, if the one or more candidate resources selected from the licensed frequency band resource pool 310 are sufficient to meet requirements of the sidelink transmission of the UE, the one or more candidate resources may be determined as the candidate resource set in step 220 without having to determine the at least one additional portion of the candidate resource set.

However, in some cases, the one or more candidate resources selected from the licensed frequency band resource pool 310 may not be sufficient to meet the requirements of the sidelink transmission of the UE. This is because the licensed frequency band resource pool 310 allocated to the UE that is available to the sidelink transmission may be limited, while the sidelink transmission of the UE requires more resources to support high throughput. In this case, the UE may be configured to select the one or more additional candidate resources from the unlicensed frequency band resource pool 320 as a second portion of the candidate resource set. This second portion is the additional portion of the candidate resource set. In this way, the UE may combine the first portion and the second portion, which are determined from the different types of resource pools, as the candidate resource set in step 220, thereby addressing the defect that the candidate resources in a single resource pool might be insufficient.

In an optional embodiment, when candidate resources selected from the earlier licensed frequency band resource pool 310 are insufficient to meet requirements of the sidelink transmission of the UE, the UE may be further configured to determine, based on QoS associated with the sidelink transmission, whether to select additional candidate resources from the unlicensed frequency band resource pool 320. For example, the UE may perform such a determination based on a delay parameter associated with the sidelink transmission. This is because the LBT operation for selecting candidate resources from the unlicensed frequency band resource pool 320 is time-consuming. If the delay allowed by the delay parameter of the sidelink transmission is large enough (e.g., greater than a threshold, thereby allowing the UE to complete the LBT operation), the UE may be configured to perform the LBT operation to select additional candidate resources that may be used for that sidelink transmission. If the delay allowed by the delay parameter of the sidelink transmission is not large enough, the UE may not perform the LBT operation.

According to an embodiment of the present disclosure, when the licensed frequency band resource pool and the unlicensed frequency band resource pool overlap in the time domain, for a portion of resources that overlap, the UE may be configured to select, from the following operations, at least one operation to perform: (1) a resource sensing operation associated with the licensed frequency band resource pool for selecting a first candidate resource set from the licensed frequency band resource pool; or (2) an LBT operation associated with the unlicensed frequency band resource pool for selecting a second candidate resource set from the unlicensed frequency band resource pool.

According to an embodiment of the present disclosure, the UE may select, based on the UE's capabilities, to perform at least one of the resource sensing operation and the LBT operation. Specifically, in response to the UE's capabilities being above a threshold condition, the UE may select to perform both the resource sensing operation and the LBT operation. In response to the UE's capabilities not being higher than the threshold condition, the UE may choose to perform one of the resource sensing operation and the LBT operation. The capabilities of the UE may involve multiple aspects of the UE, including but not limited to the communication capability, processing capability, power consumption, temperature, etc., of the UE.

In some embodiments, if the UE selects to perform both the resource sensing operation and the LBT operation, the UE may further select to start performing the resource sensing operation before the LBT operation.

As described above, the LBT operation may take a long time to complete. For example, for an LBT operation with a listening level of Cat 4, the UE needs to perform channel detection for up to 80 ms. Only if the UE has detected that the channel is idle for all the 80 ms period, the UE may obtain an occupancy time of up to 10 ms on this channel. Such detection is time consuming. Moreover, for a load-based LBT operation, the LBT operation does not perform channel detection until a packet on the channel arrives. Compared with the LBT operation, the resource sensing operation may start before the packet arrives. Therefore, a delay caused by the LBT operation may be greater than a delay caused by the resource sensing operation. According to an embodiment of the present disclosure, the UE may be configured to start performing the resource sensing operation before the LBT operation, so as to determine the candidate resource set (or at least a portion of the candidate resource set) as fast as possible.

According to an embodiment of the present disclosure, the resource sensing operation for selecting candidate resources from the licensed frequency band resource pool may include a resource exclusion operation.

When performing the resource exclusion operation, the UE may be configured to obtain a measurement result associated with each resource in a set of available resources in the licensed frequency band resource pool. The measurement result may be a metric of characteristics of a channel associated with each resource. The set of available resources may initially be a subset of resources in the licensed frequency band resource pool that overlap with the unlicensed frequency band resource pool in the time domain. The UE may be configured to compare the measurement result associated with each resource to a particular exclusion threshold. Based on the result of the comparison, the UE may exclude one or more resources that meet specific exclusion conditions from the set of available resources, thereby obtaining a reduced set of available resources. The UE may determine candidate resources from the reduced set of available resources.

As a specific example of the resource exclusion operation, the UE may be configured to obtain a reference signal received power (RSRP) of the channel associated with each resource. The UE may compare the RSRP with a RSRP threshold. If the RSRP of a channel associated with a particular resource is greater than the RSRP threshold, the UE may expect that the specific resource may be used by another device in the wireless communication system, so the resource has low reliability and is not suitable to be used as a candidate resource for the sidelink transmission of the current UE. Accordingly, the UE may exclude the particular resource from the set of available resources in the licensed frequency band resource pool. If the RSRP of the channel associated with the particular resource is not greater than the RSRP threshold, the UE may expect that the specific resource may not be used by any other device, so the resource has high reliability and is suitable to be used as a candidate resource for the sidelink transmission of the current UE. The UE may perform the above comparison process for each resource in the set of available resources. In this way, the UE may exclude one or more resources with poor performance from the set of available resources and retain one or more resources with better performance as candidate resources. It is readily understood that a lower RSRP threshold leads to a better performance of the retained candidate resources but also a smaller number of candidate resources.

In some cases, the reduced set of available resources that is obtained through a single round of resource sensing operations may not be sufficient for the sidelink transmission. For example, the number of candidate resources in the reduced set of available resources may be too few, or may not be sufficient to support a desired transmission rate. According to an embodiment of the present disclosure, the UE may increase the number of candidate resources in various ways.

In one approach, the UE may change the particular exclusion threshold associated with the resource exclusion operation. Specifically, in response to the number of resources in the reduced set of available resources being less than a specified number threshold, the UE may change the particular exclusion threshold associated with the resource exclusion operation. Accordingly, one or more resources that were excluded in a previous round of resource sensing operations may be retained in the set of available resources in a new round of resource sensing operations. In an example where the particular exclusion threshold is the RSRP threshold, the UE may increase the RSRP threshold from a first threshold to a second threshold, such that those resources corresponding to a certain RSRP value between the first threshold and the second threshold will become remained in the set of available resources rather than being excluded. However, these resources might have low reliability.

In another approach, the UE may perform the LBT operation to select a second candidate resource set from the unlicensed frequency band resource pool. The second candidate resource set may serve as additional candidate resources. The UE may combine the first candidate resource set selected from the licensed frequency band resource pool through the resource exclusion operation with the second candidate resource set selected from the unlicensed frequency band resource pool through the LBT operation, and the resulting candidate resource set will be larger than the first candidate resource set.

In this case, since there is the second candidate resource set as additional candidate resources, the UE may preferably not change the particular exclusion threshold associated with the resource exclusion operation. Specifically, during the resource sensing operation, in response to the number of resources in the reduced set of available resources being less than the specified number threshold, the UE may keep the particular exclusion threshold unchanged. In other words, if there is the second candidate resource set as a supplement, the UE may not need to change the particular exclusion threshold in the resource sensing operation to retain one or more resources with low reliability. Therefore, resources in the eventually obtained candidate resource set may have high reliability.

In yet another hybrid approach, the UE may perform both of: performing the LBT operation to select the second candidate resource set from the unlicensed frequency band resource pool, and expanding the set of available resources obtained through the resource sensing operation by changing the particular exclusion threshold associated with the resource exclusion operation. Compared with the previous two approaches, this approach allows the UE to obtain a largest candidate resource set. The largest candidate resource set might include some resources with lower reliability. This hybrid approach may be used when both the licensed frequency band resource pool and the unlicensed frequency band resource pool are insufficient.

According to an embodiment of the present disclosure, if the first candidate resource set selected by the UE from the licensed frequency band resource pool through resource sensing operation is sufficient to meet the requirements of the sidelink transmission (for example, the first candidate resource set contains enough resources, or the first candidate resource set may support high-rate data transmission), the UE may decide not to additionally perform the LBT operation. As such, the UE may not select the second candidate resource set from the unlicensed frequency band resource pool. In this case, the first candidate resource set selected by the UE from the licensed frequency band resource pool through resource sensing operation may be used as the candidate resource set determined in step 220.

In some embodiments, if the UE selects to perform both the resource sensing operation and the LBT operation based on its capabilities, the UE may further select to perform the LBT operation and the resource sensing operation in parallel. For example, for a sidelink transmission with a high priority (e.g., in response to the priority associated with the sidelink transmission being above a priority threshold), the UE may choose to perform the LBT operation and the resource sensing operation in parallel. In this case, the LBT operation performed is not a load-based LBT operation. In other words, in that LBT operation, the channel detection does not have to be performed after a packet arrives, but may be performed in advance. Specifically, the UE may predict an arrival time of the packet and start performing the LBT operation before the predicted arrival time. For some periodically transmitted packets, their arrival time may be predicted by the UE. By advancing the LBT operation such that it is performed in parallel with the resource sensing operation (rather than being performed after the resource sensing operation), the UE is able to more quickly determine the second candidate resource set from the unlicensed resource pool, thereby determining the candidate resource set faster in overall. This is especially beneficial for the sidelink transmission with a high priority.

In an optional embodiment, if the UE's capabilities are strong enough, the UE may perform the LBT operation and the resource sensing operation in parallel for also a sidelink transmission with a standard priority. Alternatively, the UE may perform the LBT operation and the resource sensing operation in parallel without taking the priority of the sidelink transmission into account.

It should be noted that in the process of performing the LBT operation and the resource sensing operation in parallel, the UE may perform the resource sensing operation in accordance with one or more of the foregoing approaches. For example, in one approach, in response to the number of resources in the reduced set of available resources being less than the specified number threshold, the UE may change the particular exclusion threshold associated with the resource exclusion operation to increase the number of resources in the set of available resources. In a preferred approach, in response to the number of resources in the reduced available resource set being less than the specified number threshold, the UE may not change the particular exclusion threshold associated with the resource exclusion operation, so as to ensure the quality of resources in the set of available resources. In either approach, the UE may use a combination of the second candidate resource set obtained through the LBT operation and the first candidate resource set obtained through the resource sensing operation, as the candidate resource set in step 220.

According to an embodiment of the present disclosure, in response to capabilities of the UE not being higher than the threshold condition, the UE may select one of the resource sensing operation and the LBT operation to perform.

In some embodiments, the UE may be configured to select, based on at least one of the following, the one of the resource sensing operation and the LBT operation to perform: a priority of a packet associated with the sidelink transmission, a size of the packet, and/or a packet delay budget associated with the packet.

In one example, if the packet has a high priority (e.g., higher than a priority threshold), the UE may choose to perform the LBT operation, through which the UE determines the second candidate resource set from the unlicensed frequency band resource pool as the candidate resource set determined in step 220. Otherwise, the UE may select to perform the resource sensing operation, through which the UE determines the first candidate resource set from the licensed frequency band resource pool as the candidate resource set determined in step 220.

In another example, if the packet has a large size (e.g., greater than a size threshold), the UE may choose to perform the LBT operation to determine a candidate resource set for sidelink transmission associated with the packet from the unlicensed frequency band resource pool. Otherwise, the UE may select to perform the resource sensing operation.

In yet another example, if the packet has a large packet delay budget (e.g., greater than a delay threshold), the UE may select to perform the LBT operation to determine the candidate resource set for sidelink transmission associated with the packet. Otherwise, the UE may select to perform the resource sensing operation.

In an optional example, the various factors above may also be considered in combination. For example, if the packet has a high priority, a large size, and a large packet delay budget, the UE may select to perform the LBT operation to determine the candidate resource set from the unlicensed frequency band resource pool for the sidelink transmission associated with the packet. Otherwise, the UE may select to perform the resource sensing operation. Other combinations of the above factors are also possible.

According to an embodiment of the present disclosure, in the process of determining the candidate resource set from the unlicensed frequency band resource pool, the UE may repeat the LBT operation until the LBT operation succeeds, or until a number of times the LBT operation is repeated reaches a failure count threshold. The LBT operation succeeds if it detects an available idle channel. If the LBT operation fails to detect any available idle channel for all resources in the unlicensed frequency band resource pool, this round of LBT operation fails. In response to a failure of the LBT operation, the UE may be configured to determine whether the LBT operation has been repeated up to the failure count threshold. If the number of times the LBT operation has been repeated has not reached the failure count threshold, the UE may start a next round of LBT operation. If the number of times the LBT operation has been repeated reaches the failure count threshold, the UE may stop the LBT operation.

In some embodiments, the failure count threshold associated with the LBT operation may be determined based on a priority of the packet associated with the sidelink transmission. For example, for a packet with a high priority (e.g., higher than a priority threshold), a lower failure count threshold may be specified to ensure that data with the high priority may be sent in time. For a packet with a low priority (for example, not higher than the priority threshold), a higher failure count threshold may be specified. In one example, a portion of the resource configuration information may include mapping information between the failure count threshold and the priority of the packet. By accessing the mapping information, the UE may determine a corresponding failure count threshold based on a priority of a packet associated with a sidelink transmission. The UE may apply the determined failure count threshold to the LBT operation associated with the packet. The mapping information may be configured through the resource configuration information, as a portion of configuration information of the unlicensed frequency band resource pool. Preferably, the mapping information may be provided to the UE in a preconfigured manner.

It should be understood that, for the LBT operation in various situations described in the present disclosure, a corresponding failure count threshold may be determined based on the priority of packet associated with the sidelink transmission.

According to an embodiment of the present disclosure, if the UE selects, from the resource sensing operation and the LBT operation, the LBT operation to perform, and if the number of times the LBT operation has been repeated has reached the failure count threshold, the UE may stop the LBT operation and turn to perform the resource sensing operation. The UE determines the first candidate resource set from the licensed frequency band resource pool through this resource sensing operation as the candidate resource set determined in step 220.

According to an embodiment of the present disclosure, after determining the candidate resource set in step 220, the UE may select one or more resources from the candidate resource set to perform the sidelink transmission of the UE. The resources actually used for the sidelink transmission may be a subset of the candidate resource set.

According to an embodiment of the present disclosure, the UE may be configured to enable one or both of the licensed frequency band resource pool and/or the unlicensed frequency band resource pool. For example, the UE may receive a signaling from the base station, which may indicate to the UE as to the capability of enabling the licensed frequency band resource pool and/or the unlicensed frequency band resource pool. This signaling may be of a variety of types (e.g., with different parameters). A first type of signaling may instruct the UE to enable only the licensed frequency band resource pool. A second type of signaling may instruct the UE to enable only the unlicensed frequency band resource pool. A third type of signaling may instruct the UE to enable both of the licensed frequency band resource pool and the unlicensed frequency band resource pool. In response to receiving the signaling, the UE may be configured to enable a particular resource pool as indicated by the signaling. In some embodiments, the base station may determine, based on the capabilities reported by the UE, a type of signaling to be issued.

It should be understood that method 200 is exemplary only. Those skilled in the art may understand that the method on the UE side may not only include those steps that have been described with respect to the method 200, but may also include one or more of the steps of any previously described method.

The methods and devices described in the disclosure provide both the licensed frequency band resource pool and the unlicensed frequency band resource pool for the sidelink transmission, so that the sidelink communication may support a higher transmission rate as well as more services. With both the licensed frequency band resource pool and the unlicensed frequency band resource pool, the method for resource selection according to the present disclosure may select a suitable candidate resource set from the two resource pools for the sidelink transmission of the UE.

### 3. Examples of Application

The technology of the present disclosure may be applied to various products.

For example, a control-side electronic device according to an embodiment of the present disclosure may be implemented as or included in various control devices/base stations. For example, a transmitting device and a terminal device according to an embodiment of the present disclosure may be implemented as or included in various terminal devices.

For example, the control device/base station mentioned in the present disclosure may be implemented as any type of base station, for example eNB, such as macro eNB and small eNB. A small eNB may be an eNB that covers a cell smaller than a macro cell, such as a pico eNB, a micro eNB, and a home (femto) eNB. For another example, it may be implemented as a gNB, such as a macro gNB and a small gNB. A small gNB may be a gNB covering a cell smaller than a macro cell, such as a pico gNB, a micro gNB, and a home (femto) gNB. Alternatively, the base station may be implemented as any other type of base station, such as NodeB and Base Transceiver Station (BTS). The base station may include: a main body (also referred to as a base station device) configured to control radio communication; and one or more Remote Radio Heads (RRHs) disposed at a different location from the main body. In addition, various types of terminals to be described below may each operate as a base station by performing base station functions temporarily or semi-persistently.

For example, the terminal devices mentioned in the present disclosure may be implemented as mobile terminals (such as smart phones, tablet personal computers (PCs), notebook PCs, portable game terminals, portable/dongle-type mobile routers and digital cameras) or vehicle-mounted terminals (such as vehicle navigation devices) in some embodiments. The terminal device may also be implemented as a terminal performing machine-to-machine (M2M) communication (also referred to as a machine type communication (MTC) terminal). In addition, the terminal device may be a radio communication module (such as an integrated circuit module including a single wafer) mounted on each of the above terminals.

Application examples according to the present disclosure will be described below with reference to the drawings.

### Examples of Base Stations

It should be understood that the term base station in the present disclosure has the full breadth of its ordinary meaning, and includes at least a radio communication station used as portion of a wireless communication system or radio system to facilitate communication. Examples of the base station may be, for example but not limited to, the following: the base station may be either or both of a base transceiver station (BTS) and a base station controller (BSC) in the GSM system, and may be either or both of a radio network controller (RNC) or Node B in the WCDMA system, may be eNB in the LTE and LTE-Advanced system, or may be corresponding network nodes in future communication systems (e.g., the gNB that may appear in the 5G communication systems, eLTE eNB, etc.). Some of the functions in the base station of the present disclosure may also be implemented as an entity having a control function for communication in the scenario of a D2D, M2M, V2V and V2X communication, or as an entity that plays a spectrum coordination role in the scenario of a cognitive radio communication.

### First Example

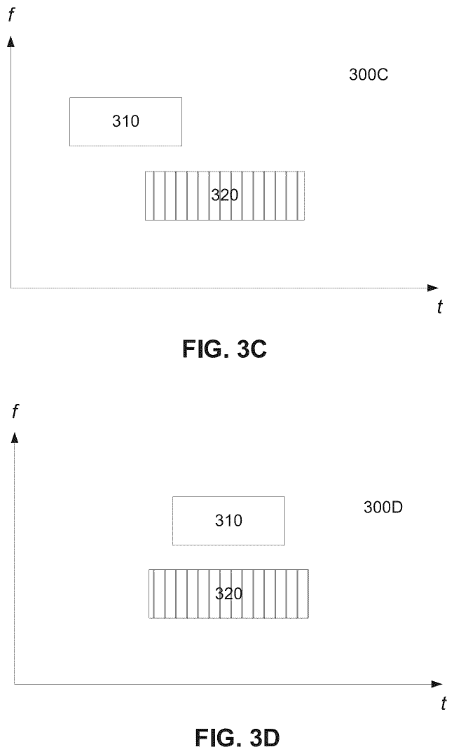

FIG. 4 is a block diagram showing a first example of a schematic configuration of a gNB to which the technology of the present disclosure may be applied. The gNB 2100 includes multiple antennas 2110 and a base station device 2120. The base station device 2120 and each antenna 2110 may be connected to each other via an RF cable. In one implementation, the gNB 2100 (or the base station device 2120) here may correspond to the above electronic device on the control side.

Each of the antennas 2110 includes a single or multiple antenna elements (such as multiple antenna elements included in a Multiple Input Multiple Output (MIMO) antenna), and is used for the base station device 2120 to send and receive wireless signals. As shown in FIG. 4, gNB 2100 may include multiple antennas 2110. For example, multiple antennas 2110 may be compatible with multiple frequency bands used by gNB 2100.

The base station device 2120 includes a controller 2121, a memory 2122, a network interface 2123 and a wireless communication interface 2125.

The controller 2121 may be, for example, a CPU or a DSP, and operates various functions of a higher layers of the base station device 2120. For example, the controller 2121 determines location information of a target terminal device in the at least one terminal devices according to the positioning information of at least one terminal device on the terminal side in the wireless communication system and a specific location configuration information of the at least one terminal device acquired by the wireless communication interface 2125. The controller 2121 may have a logical function to perform control such as radio resource control, radio bearer control, mobility management, access control and scheduling. This control may be performed in conjunction with nearby gNBs or core network nodes. The memory 2122 includes RAM and ROM, and stores programs executed by the controller 2121 and various types of control data (such as a terminal list, transmission power data, and scheduling data).

The network interface 2123 is a communication interface for connecting the base station device 2120 to the core network 2124. The controller 2121 may communicate with the core network node or another gNB via the network interface 2123. In this case, the gNB 2100 and the core network node or other gNB may be connected to each other through logical interfaces such as SI interface and X2 interface. The network interface 2123 may also be a wired communication interface or a wireless communication interface for wireless backhaul. If the network interface 2123 is a wireless communication interface, the network interface 2123 may use a higher frequency band for wireless communication than the frequency band used by the wireless communication interface 2125.

The wireless communication interface 2125 supports any cellular communication scheme such as Long Term Evolution (LTE) and LTE-Advanced, and provides a wireless connection to terminals located in a cell of the gNB 2100 via the antenna 2110. The wireless communication interface 2125 may generally include, for example, a baseband (BB) processor 2126 and an RF circuit 2127. The BB processor 2126 may perform, for example, encoding/decoding, modulation/demodulation, and multiplexing/demultiplexing, and perform various types of signal processing for layers (such as L1, Medium Access Control (MAC), Radio Link Control (RLC), and Packet Data Convergence Protocol (PDCP)). Instead of the controller 2121, the BB processor 2126 may have a part or all of the logic functions described above. The BB processor 2126 may be a memory storing a communication control program, or a module including a processor configured to execute a program and related circuits. The update program may cause the function of the BB processor 2126 to change. The module may be a card or a blade inserted into a slot of the base station device 2120. Alternatively, the module may also be a chip mounted on a card or blade. Meanwhile, the RF circuit 2127 may include, for example, a mixer, a filter, and an amplifier, and transmit and receive wireless signals via the antenna 2110. Although FIG. 4 illustrates an example in which one RF circuit 2127 is connected to one antenna 2110, the present disclosure is not limited to this illustration, instead one RF circuit 2127 may be connected to multiple antennas 2110 at the same time.

As shown in FIG. 4, the wireless communication interface 2125 may include multiple BB processors 2126. For example, multiple BB processors 2126 may be compatible with multiple frequency bands used by gNB 2100. As shown in FIG. 4, the wireless communication interface 2125 may include multiple RF circuits 2127. For example, the multiple RF circuits 2127 may be compatible with multiple antenna elements. Although FIG. 4 illustrates an example in which the wireless communication interface 2125 includes multiple BB processors 2126 and multiple RF circuits 2127, the wireless communication interface 2125 may also include a single BB processor 2126 or a single RF circuit 2127.

### Second Example

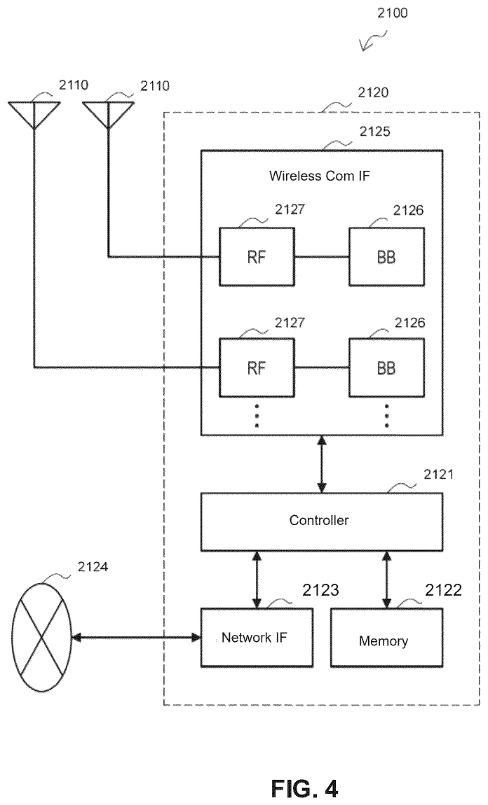

FIG. 5 is a block diagram showing a second example of a schematic configuration of a gNB to which the technology of the present disclosure may be applied. The gNB 2200 includes multiple antennas 2210, RRH 2220 and base station device 2230. The RRH 2220 and each antenna 2210 may be connected to each other via an RF cable. The base station device 2230 and the RRH 2220 may be connected to each other via a high-speed line such as an optical fiber cable. In one implementation, the gNB 2200 (or the base station device 2230) here may correspond to the above electronic device on the control side.

Each of the antennas 2210 includes a single or multiple antenna elements (such as multiple antenna elements included in a MIMO antenna), and is used for the RRH 2220 to send and receive wireless signals. As shown in FIG. 5, the gNB 2200 may include multiple antennas 2210. For example, the multiple antennas 2210 may be compatible with multiple frequency bands used by the gNB 2200.

The base station device 2230 includes a controller 2231, a memory 2232, a network interface 2233, a wireless communication interface 2234 and a connection interface 2236. The controller 2231, the memory 2232, and the network interface 2233 are the same as the controller 2121, the memory 2122, and the network interface 2123 described with reference to FIG. 4.

The wireless communication interface 2234 supports any cellular communication scheme (such as LTE and LTE-Advanced), and provides wireless communication to terminals located in a sector corresponding to the RRH 2220 via the RRH 2220 and the antenna 2210. The wireless communication interface 2234 may generally include, for example, a BB processor 2235. The BB processor 2235 is the same as the BB processor 2126 described with reference to FIG. 4 except that the BB processor 2235 is connected to the RF circuit 2222 of the RRH 2220 via the connection interface 2236. As shown in FIG. 5, the wireless communication interface 2234 may include multiple BB processors 2235. For example, the multiple BB processors 2235 may be compatible with multiple frequency bands used by the gNB 2200. Although FIG. 5 illustrates an example in which the wireless communication interface 2234 includes multiple BB processors 2235, the wireless communication interface 2234 may also include a single BB processor 2235.

The connection interface 2236 is an interface for connecting the base station device 2230 (wireless communication interface 2234) to the RRH 2220. The connection interface 2236 may also be a communication module for communication in the above high-speed line connecting the base station device 2230 (wireless communication interface 2234) to the RRH 2220.

The RRH 2220 includes a connection interface 2223 and a wireless communication interface 2221.

The connection interface 2223 is an interface for connecting the RRH 2220 (wireless communication interface 2221) to the base station device 2230. The connection interface 2223 may also be a communication module used for communication in the above high-speed line.

The wireless communication interface 2221 transmits and receives wireless signals via the antenna 2210. Wireless communication interface 2221 may generally include RF circuitry 2222, for example. The RF circuit 2222 may include, for example, a mixer, a filter, and an amplifier, and transmits and receives wireless signals via the antenna 2210. Although FIG. 5 illustrates an example in which one RF circuit 2222 is connected to one antenna 2210, the present disclosure is not limited to this illustration, instead one RF circuit 2222 may be connected to multiple antennas 2210 at the same time.

As shown in FIG. 5, the wireless communication interface 2221 may include multiple RF circuits 2222. For example, the multiple RF circuits 2222 may support multiple antenna elements. Although FIG. 5 illustrates an example in which the wireless communication interface 2221 includes multiple RF circuits 2222, the wireless communication interface 2221 may also include a single RF circuit 2222.

### Examples of User Device/Terminal Device

### First Example

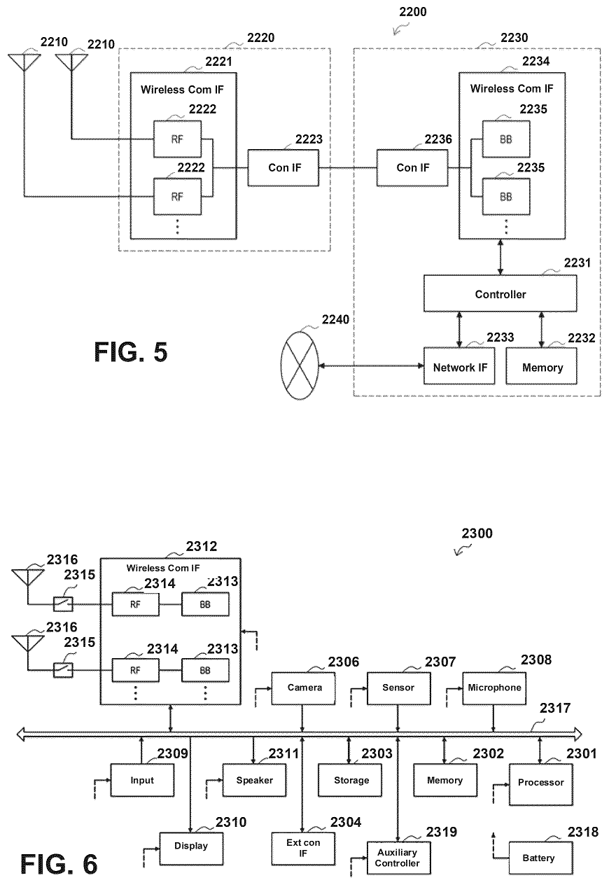

FIG. 6 is a block diagram showing an example of a schematic configuration of a communication device 2300 (e.g., a smart phone, a communicator, etc.) to which the techniques of the present disclosure may be applied. The communication device 2300 includes a processor 2301, a memory 2302, a storage apparatus 2303, an external connection interface 2304, a camera apparatus 2306, a sensor 2307, a microphone 2308, an input apparatus 2309, a display apparatus 2310, a speaker 2311, a wireless communication interface 2312, one or more antenna switches 2315, one or more antennas 2316, a bus 2317, a battery 2318, and an auxiliary controller 2319. In one implementation, the communication device 2300 (or the processor 2301) here may correspond to the above transmitting device or electronic device on the terminal side.

The processor 2301 may be, for example, a CPU or a system on chip (SoC), and controls functions of an application layer and other layers of the communication device 2300. The memory 2302 includes RAM and ROM, and stores data and programs executed by the processor 2301. The storage apparatus 2303 may include a storage medium such as a semiconductor memory and a hard disk. The external connection interface 2304 is an interface for connecting an external apparatus (such as a memory card and a universal serial bus (USB) apparatus) to the communication device 2300.

The camera apparatus 2306 includes an image sensor (such as a charge coupled device (CCD) and a complementary metal oxide semiconductor (CMOS)), and generates a captured image. Sensors 2307 may include a set of sensors such as measurement sensors, gyro sensors, geomagnetic sensors, and acceleration sensors. The microphone 2308 converts sound input to the communication device 2300 into an audio signal. The input apparatus 2309 includes, for example, a touch sensor configured to detect a touch on the screen of the display apparatus 2310, a keypad, a keyboard, buttons, or switches, and receives operations or information input from a user. The display apparatus 2310 includes a screen (such as a Liquid Crystal Display (LCD) and an Organic Light Emitting Diode (OLED) display), and displays an image output by the communication device 2300. The speaker 2311 converts an audio signal output from the communication device 2300 into sound.

The wireless communication interface 2312 supports any cellular communication scheme (such as LTE and LTE-Advanced), and performs wireless communication. The wireless communication interface 2312 may generally include, for example, a BB processor 2313 and an RF circuit 2314. The BB processor 2313 may perform, for example, encoding/decoding, modulation/demodulation, and multiplexing/demultiplexing, and perform various types of signal processing for wireless communication. Meanwhile, the RF circuit 2314 may include, for example, a mixer, a filter, and an amplifier, and transmit and receive wireless signals via the antenna 2316. The wireless communication interface 2312 may be a chip module on which a BB processor 2313 and an RF circuit 2314 are integrated. As shown in FIG. 6, the wireless communication interface 2312 may include multiple BB processors 2313 and multiple RF circuits 2314. Although FIG. 6 illustrates an example in which the wireless communication interface 2312 includes multiple BB processors 2313 and multiple RF circuits 2314, the wireless communication interface 2312 may also include a single BB processor 2313 or a single RF circuit 2314.

In addition, the wireless communication interface 2312 may support another type of wireless communication scheme, such as a short-range wireless communication scheme, a near field communication scheme, and a wireless local area network (LAN) scheme, in addition to the cellular communication scheme. In this case, the wireless communication interface 2312 may include a BB processor 2313 and an RF circuit 2314 for each wireless communication scheme.

Each of the antenna switches 2315 switches the connection destination of the antenna 2316 among multiple circuits included in the wireless communication interface 2312 (e.g., circuits for different wireless communication schemes).

Each of the antennas 2316 includes a single or multiple antenna elements (such as multiple antenna elements included in a MIMO antenna), and is used for the wireless communication interface 2312 to transmit and receive wireless signals. As shown in FIG. 6, the communication device 2300 may include multiple antennas 2316. Although FIG. 6 illustrates an example in which the communication device 2300 includes multiple antennas 2316, the communication device 2300 may also include a single antenna 2316.

In addition, the communication device 2300 may include an antenna 2316 for each wireless communication scheme. In this case, the antenna switch 2315 may be omitted from the configuration of the communication device 2300.

The bus 2317 connects the processor 2301, memory 2302, storage apparatus 2303, external connection interface 2304, camera apparatus 2306, sensor 2307, microphone 2308, input apparatus 2309, display apparatus 2310, speaker 2311, wireless communication interface 2312, and auxiliary controller 2319 to each other. The battery 2318 provides power to the various blocks of the communication device 2300 shown in FIG. 6 via feed lines, which are partially shown as dashed lines in the figure. The auxiliary controller 2319 operates the minimum necessary functions of the communication device 2300 in sleep mode, for example.

### Second Example

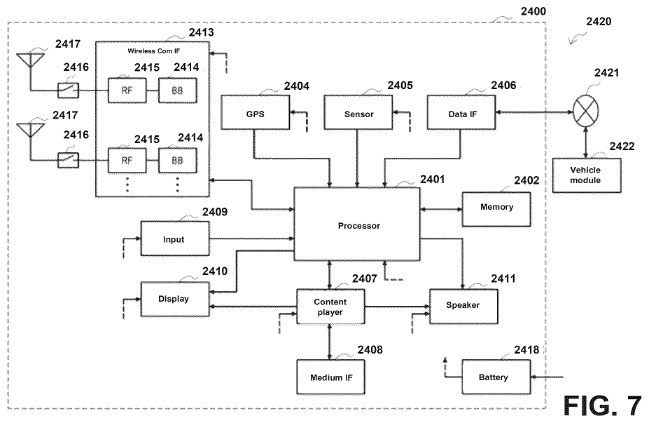

FIG. 7 is a block diagram showing an example of a schematic configuration of a vehicle navigation device 2400 to which the technology of the present disclosure may be applied. The vehicle navigation device 2400 includes a processor 2401, a memory 2402, a global positioning system (GPS) module 2404, a sensor 2405, a data interface 2406, a content player 2407, a storage medium interface 2408, an input apparatus 2409, a display apparatus 2510, a speaker 2411, a wireless communication interface 2413, one or more antenna switches 2416, one or more antennas 2417, and a battery 2418. In one implementation, the vehicle navigation device 2400 (or the processor 2401) here may correspond to a transmitting device or a terminal-side electronic device.

The processor 2401 may be, for example, a CPU or a SoC, and controls the navigation function and other functions of the vehicle navigation device 2400. The memory 2402 includes RAM and ROM, and stores data and programs executed by the processor 2401.

The GPS module 2404 measures the location (such as latitude, longitude, and altitude) of the vehicle navigation device 2400 using GPS signals received from GPS satellites. The sensors 2405 may include a set of sensors such as gyroscopic sensors, geomagnetic sensors, and air pressure sensors. The data interface 2406 is connected to, for example, the in-vehicle network 2421 via a terminal not shown, and acquires data generated by the vehicle (such as vehicle speed data).

The content player 2407 reproduces content stored in a storage medium (such as CD and DVD), which is inserted into the storage medium interface 2408. The input apparatus 2409 includes, for example, a touch sensor configured to detect a touch on the screen of the display apparatus 2510, a button, or a switch, and receives an operation or information input from a user. The display apparatus 2510 includes a screen such as an LCD or OLED display, and displays an image of a navigation function or reproduced content. The speaker 2411 outputs sound of a navigation function or reproduced content.

The wireless communication interface 2413 supports any cellular communication scheme such as LTE and LTE-Advanced, and performs wireless communication. The wireless communication interface 2413 may generally include, for example, a BB processor 2414 and an RF circuit 2415. The BB processor 2414 may perform, for example, encoding/decoding, modulation/demodulation, and multiplexing/demultiplexing, and perform various types of signal processing for wireless communication. Meanwhile, the RF circuit 2415 may include, for example, a mixer, a filter, and an amplifier, and transmit and receive wireless signals via the antenna 2417. The wireless communication interface 2413 may also be a chip module on which the BB processor 2414 and the RF circuit 2415 are integrated. As shown in FIG. 7, the wireless communication interface 2413 may include multiple BB processors 2414 and multiple RF circuits 2415. Although FIG. 7 illustrates an example in which the wireless communication interface 2413 includes multiple BB processors 2414 and multiple RF circuits 2415, the wireless communication interface 2413 may also include a single BB processor 2414 or a single RF circuit 2415.

In addition, the wireless communication interface 2413 may support another type of wireless communication scheme, such as a short-distance wireless communication scheme, a near field communication scheme, and a wireless LAN scheme, in addition to the cellular communication scheme. In this case, the wireless communication interface 2413 may include a BB processor 2414 and an RF circuit 2415 for each wireless communication scheme.

Each of the antenna switches 2416 switches the connection destination of the antenna 2417 among multiple circuits included in the wireless communication interface 2413 (such as circuits for different wireless communication schemes).

Each of the antennas 2417 includes a single or multiple antenna elements (such as multiple antenna elements included in a MIMO antenna), and is used for the wireless communication interface 2413 to transmit and receive wireless signals. As shown in FIG. 7, the vehicle navigation device 2400 may include multiple antennas 2417. Although FIG. 7 illustrates an example in which the vehicle navigation device 2400 includes multiple antennas 2417, the vehicle navigation device 2400 may also include a single antenna 2417.

In addition, the vehicle navigation device 2400 may include an antenna 2417 for each wireless communication scheme. In this case, the antenna switch 2416 may be omitted from the configuration of the vehicle navigation device 2400.

The battery 2418 provides power to various blocks of the vehicle navigation device 2400 shown in FIG. 7 via feeder lines, which are partially shown as dotted lines in the figure. The battery 2418 accumulates electric power supplied from the vehicle.

The technology of the present disclosure may also be implemented as an in-vehicle system (or vehicle) 2420 including one or more blocks in a vehicle navigation device 2400, an in-vehicle network 2421, and a vehicle module 2422. The vehicle module 2422 generates vehicle data (such as vehicle speed, engine speed, and breakdown information), and outputs the generated data to the in-vehicle network 2421.

The exemplary embodiments of the present disclosure are described above with reference to the accompanying drawings, but the present disclosure is of course not limited to the above examples. A person skilled in the art may find various alterations and modifications within the scope of the appended claims, and it should be understood that they will naturally come under the technical scope of the present disclosure.

It should be understood that the machine-readable storage medium or the machine-executable instructions in the program product according to the embodiments of the present disclosure may be configured to perform operations corresponding to the above device and method embodiments. When referring to the above device and method embodiments, the embodiments of the machine-readable storage medium or the program product will be obvious to those skilled in the art, so the description will not be repeated. Machine-readable storage media and program products for carrying or including the above machine-executable instructions also fall within the scope of the present disclosure. Such storage media may include, but are not limited to, floppy disks, optical disks, magneto-optical disks, memory cards, memory sticks, and the like.

In addition, it should be understood that the series of processes and devices described above may also be implemented by software and/or firmware. In the case of implemented by software and/or firmware, respective programs constituting the respective software are stored in the storage medium of the related device, and various functions may be performed when the programs are executed.

For example, multiple functions included in one unit in the above embodiments may be implemented by separate apparatus. Alternatively, multiple functions implemented by multiple units in the above embodiments may be respectively implemented by separate apparatus. In addition, one of the above functions may be realized by multiple units. Needless to say, such a configuration is included in the technical scope of the present disclosure.

In this specification, the steps described in the flowcharts include not only processing performed in time series in the stated order but also processing performed in parallel or individually and not necessarily in time series. Furthermore, even in the steps processed in time series, needless to say, the order may be appropriately changed.

### 4. Exemplary Embodiments of the Present Disclosure

According to the embodiments of the present disclosure, various exemplary implementations for realizing the concepts of the present disclosure may be conceived, including but not limited to the following embodiments:
1. An electronic device for a user equipment (UE), comprising:
processing circuitry configured to:
   determine, based on resource configuration information, a licensed frequency band resource pool and an unlicensed frequency band resource pool that are available to a sidelink transmission of the UE; and
   determine, from the licensed frequency band resource pool and the unlicensed frequency band resource pool, a candidate resource set for the sidelink transmission of the UE.
2. The electronic device of embodiment 1, wherein the resource configuration information is preconfigured and/or is dynamically configured by a signaling from a base station.
3. The electronic device of embodiment 1, wherein, when the licensed frequency band resource pool and the unlicensed frequency band resource pool do not overlap in time domain, the processing circuitry is configured to:
select, from one resource pool that is earlier in time domain of the licensed frequency band resource pool and the unlicensed frequency band resource pool, one or more candidate resources as at least a portion of the candidate resource set.
4. The electronic device of embodiment 3, wherein the processing circuitry is further configured to:
select, from one resource pool that is later in time domain of the licensed frequency band resource pool and the unlicensed frequency band resource pool, one or more additional candidate resources as at least an additional portion of the candidate resource set.
5. The electronic device of embodiment 1, wherein, when the licensed frequency band resource pool and the unlicensed frequency band resource pool overlap at least in part in time domain, the processing circuitry is configured to:
Select, from following operations, at least one operation to perform:
   a resource sensing operation associated with the licensed frequency band resource pool, for selecting a first candidate resource set from the licensed frequency band resource pool; or
   a Listen Before Talk operation associated with the unlicensed frequency band resource pool, for selecting a second candidate resource set from the unlicensed frequency band resource pool.
6. The electronic device of embodiment 5, wherein the processing circuitry is configured to: select the at least one operation based on capabilities of the UE.
7. The electronic device of embodiment 6, wherein the processing circuitry is configured to:
in response to the capabilities of the UE being higher than a threshold condition, perform both the resource sensing operation and the Listen Before Talk operation.
8. The electronic device of embodiment 7, wherein the processing circuitry is configured to:
start performing the resource sensing operation before the Listen Before Talk operation.
9. The electronic device of embodiment 7, wherein the processing circuitry is configured to:
perform the Listen Before Talk operation and the resource sensing operation in parallel.
10. The electronic device of embodiment 9, wherein the processing circuitry is configured to:
in response to a priority associated with the sidelink transmission being higher than a predetermined priority threshold, perform the resource sensing operation and the Listen Before Talk operation in parallel.
11. The electronic device of embodiment 9, wherein the processing circuitry is further configured to:
predict an arrival time of a packet; and
perform the Listen Before Talk operation based on the predicted arrival time.
12. The electronic device of embodiment 7, wherein the resource sensing operation includes a resource exclusion operation, the resource exclusion operation comprising:
comparing a measurement result associated with each resource in a set of available resources in the licensed frequency band resource pool to a particular exclusion threshold; and
based on the comparison, excluding one or more resources from the set of available resources to obtain a reduced set of available resources.
13. The electronic device of embodiment 12, wherein the processing circuitry is further configured to:
in response to a number of resources in the reduced set of available resources being less than a specified number threshold, change the particular exclusion threshold.
14. The electronic device of embodiment 12, wherein the processing circuitry is further configured to:
in response to a number of resources in the reduced set of available resources being less than the specified number threshold, keep the particular exclusion threshold unchanged.
15. The electronic device of embodiment 6, wherein the processing circuitry is configured to:
in response to the capabilities of the UE not being higher than a threshold condition, select one of the resource sensing operation and the Listen Before Talk operation to perform.
16. The electronic device of embodiment 15, wherein the processing circuitry is configured to:
select the one of the resource sensing operation and the Listen Before Talk operation based on at least one of:
   a priority of a packet associated with the sidelink transmission;
   a size of the packet; or
   a packet delay budget associated with the packet.
17. The electronic device of embodiment 15, wherein the processing circuitry is further configured to:
in response to the selection of the Listen Before Talk operation to perform:
   in response to a number of failures of the Listen Before Talk operation reaching a failure count threshold:
      stop performing the Listen Before Talk operation, and
      perform the resource sensing operation.
18. The electronic device of embodiment 17, wherein the failure count threshold is determined based on a priority of a packet associated with the sidelink transmission.
19. The electronic device of embodiment 18, wherein a portion of the resource configuration information includes mapping information between the specified failure count threshold and the priority of the packet.
20. The electronic device of embodiment 1, wherein the processing circuitry is further configured to:
   select, from the candidate resource set, one or more resources to perform the sidelink transmission of the UE.
21. The electronic device of embodiment 1, wherein the processing circuitry is further configured to:
receive, from a base station, a signaling instructing the UE to enable the licensed frequency band resource pool and/or the unlicensed frequency band resource pool; and
enable the resource pools as indicated by the signaling.
22. A method performed by a user equipment (UE), comprising:
determining, based on resource configuration information, a licensed frequency band resource pool and an unlicensed frequency band resource pool that are available to a sidelink transmission of the UE; and
determining, from the licensed frequency band resource pool and the unlicensed frequency band resource pool, a candidate resource set for the sidelink transmission of the UE.
23. A computer-readable storage medium having one or more instructions stored thereon, which, when executed by one or more processing circuits of an electronic device, cause the electronic device to perform the method of embodiment 22.
24. A computer program product comprising a computer program, which, when executed by a processor, performs the method of embodiment 22.
25. An apparatus comprising means for performing the method of embodiment 22.

1. An electronic device for a user equipment (UE), comprising:
at least one processor; and
at least one memory including computer program code, where the at least one memory and the computer program code are configured, with the at least one processor, to cause the electronic device to:
determine, based on resource configuration information, a licensed frequency band resource pool and an unlicensed frequency band resource pool that are available to a sidelink transmission of the UE; and
determine, from the licensed frequency band resource pool and the unlicensed frequency band resource pool, a candidate resource set for the sidelink transmission of the UE.

2. The electronic device of claim 1, wherein the resource configuration information is preconfigured and/or is dynamically configured by a signaling from a base station.

3. The electronic device of claim 1, wherein, when the licensed frequency band resource pool and the unlicensed frequency band resource pool do not overlap in time domain, the processing circuitry is configured to:
select, from one resource pool that is earlier in time domain of the licensed frequency band resource pool and the unlicensed frequency band resource pool, one or more candidate resources as at least a portion of the candidate resource set.

4. The electronic device of claim 3, wherein the processing circuitry is further configured to:
select, from one resource pool that is later in time domain of the licensed frequency band resource pool and the unlicensed frequency band resource pool, one or more additional candidate resources as at least an additional portion of the candidate resource set.

5. The electronic device of claim 1, wherein, when the licensed frequency band resource pool and the unlicensed frequency band resource pool overlap at least in part in time domain, the processing circuitry is configured to:
Select, from following operations, at least one operation to perform:
a resource sensing operation associated with the licensed frequency band resource pool, for selecting a first candidate resource set from the licensed frequency band resource pool: or
a Listen Before Talk operation associated with the unlicensed frequency band resource pool, for selecting a second candidate resource set from the unlicensed frequency band resource pool.

6. The electronic device of claim 5, wherein the processing circuitry is configured to:
select the at least one operation based on capabilities of the UE.

7. The electronic device of claim 6, wherein the processing circuitry is configured to:
in response to the capabilities of the UE being higher than a threshold condition, perform both the resource sensing operation and the Listen Before Talk operation.

8. The electronic device of claim 7, wherein the processing circuitry is configured to:
start performing the resource sensing operation before the Listen Before Talk operation.

9. The electronic device of claim 7, wherein the processing circuitry is configured to:
perform the Listen Before Talk operation and the resource sensing operation in parallel.

10. The electronic device of claim 9, wherein the processing circuitry is configured to:
in response to a priority associated with the sidelink transmission being higher than a predetermined priority threshold, perform the resource sensing operation and the Listen Before Talk operation in parallel.

11. The electronic device of claim 9, wherein the processing circuitry is further configured to:
predict an arrival time of a packet; and
perform the Listen Before Talk operation based on the predicted arrival time.

12. The electronic device of claim 7, wherein the resource sensing operation includes a resource exclusion operation, the resource exclusion operation comprising:
comparing a measurement result associated with each resource in a set of available resources in the licensed frequency band resource pool to a particular exclusion threshold; and
based on the comparison, excluding one or more resources from the set of available resources to obtain a reduced set of available resources.

13. The electronic device of claim 12, wherein the processing circuitry is further configured to:
in response to a number of resources in the reduced set of available resources being less than a specified number threshold, change the particular exclusion threshold; or
in response to a number of resources in the reduced set of available resources being less than the specified number threshold, keep the particular exclusion threshold unchanged.

14. (canceled)

15. The electronic device of claim 6, wherein the processing circuitry is configured to:
in response to the capabilities of the UE not being higher than a threshold condition, select one of the resource sensing operation and the Listen Before Talk operation to perform.

16. The electronic device of claim 15, wherein the processing circuitry is configured to:
select the one of the resource sensing operation and the Listen Before Talk operation based on at least one of:
a priority of a packet associated with the sidelink transmission;
a size of the packet: or
a packet delay budget associated with the packet.

17. The electronic device of claim 15, wherein the processing circuitry is further configured to:
in response to the selection of the Listen Before Talk operation to perform:
in response to a number of failures of the Listen Before Talk operation reaching a failure count threshold:
stop performing the Listen Before Talk operation, and
perform the resource sensing operation.

18. The electronic device of claim 17, wherein the failure count threshold is determined based on a priority of a packet associated with the sidelink transmission.

19. The electronic device of claim 18, wherein a portion of the resource configuration information includes mapping information between the specified failure count threshold and the priority of the packet.

20. The electronic device of claim 1, wherein the processing circuitry is further configured to:
select, from the candidate resource set, one or more resources to perform the sidelink transmission of the UE; and
wherein the processing circuitry is further configured to:
receive, from a base station, a signaling instructing the UE to enable the licensed frequency band resource pool and/or the unlicensed frequency band resource pool; and
enable the resource pools as indicated by the signaling.

21. (canceled)

22. A method performed by a user equipment (UE), comprising:
determining, based on resource configuration information, a licensed frequency band resource pool and an unlicensed frequency band resource pool that are available to a sidelink transmission of the UE; and
determining, from the licensed frequency band resource pool and the unlicensed frequency band resource pool, a candidate resource set for the sidelink transmission of the UE.

23.-25. (canceled)
